(19) United States
(12) Patent Application Publication
(10) Pub. No.: US 2025/0074260 A1
(43) Pub. Date: Mar. 6, 2025

(54) VEHICLE SEAT ASSEMBLY COMPRISING A LATCHING DEVICE

(71) Applicant: FAURECIA Sièges d'Automobile, NANTERRE (FR)

(72) Inventors: Sylvain ROCHE, VARENNES CHANGY (FR); Farouk BOUZID, BRETIGNY SUR ORGE (FR); David EPAUD, LARDY (FR)

(21) Appl. No.: 18/817,923

(22) Filed: Aug. 28, 2024

(30) Foreign Application Priority Data
Aug. 29, 2023 (FR) 2309034

(51) Int. Cl. B60N 2/04; B60N 2/12

(52) U.S. Cl. CPC B60N 2/045; B60N 2/12

(57) ABSTRACT

A vehicle seat assembly comprises a squab frame, a slideway and a latching device selectively activatable to lock/unlock movement of the squab frame relative to a movable profile of the slideway. The latching device comprises a shaft, a hook movable between a latched position of the latching device and an unlatched position of the latching device, a latch cam movable to selectively latch the hook in its latched position, and a device for driving the latch cam between a latched position of the hook in its latched position of the latching device and another position. The drive device comprises a cam which drives the latch cam into motion as it travels along a fixed cam track.

### PRIORITY CLAIM

This application claims priority to French Patent Application FR2309034, filed Aug. 29, 2023, which is expressly incorporated by reference herein.

### BACKGROUND

The present disclosure relates to a vehicle seat assembly. A method for operating such a vehicle seat assembly is also described.

### SUMMARY

According to the present disclosure, a vehicle seat assembly comprises:
a squab frame;
at least one slideway comprising a movable section received in translation in a fixed section, intended to be fixed to a motor vehicle chassis, the squab frame being mounted so as to be movable relative to the movable section;
a selectively activatable latching device for latching/unlatching at least one movement of the squab frame relative to the movable section, the latching device comprising:
   a shaft integral with the movable section,
   a hook movable between a latched position of the latching device, wherein the hook grips the shaft, and an unlatched position of the latching device, the movable hook being connected to the squab frame, in particular mounted so as to be rotatable relative to the squab frame about a transverse axis,
   a movable latch cam for selectively latching the hook in its latched position of the latching device,
   a device for driving the latch cam between a latched position of the hook in its latched position of the latching device and at least one other position, the drive device of the latch cam comprising a first cam and a cam track adapted so that the first cam drives the latch cam into motion as it travels along the cam track, the cam track being fixed relative to the fixed section.

In this way, the latching device may be purely mechanical, devoid of any electrical or electronic devices, and be adapted to be unlatched when needed, in particular depending on the kinematics to be applied to the seat assembly.

According to preferred embodiments, the seat assembly comprises one or more of the following features, taken alone or in combination:
the latch cam, in a first latched position, holds the hook in a latched position of the latching device, and, in a second latched position, holds the hook in an unlatched position of the latching device;
the latch cam is resiliently biased towards a position in which it holds the hook in its latched position of the latching device, for example by means of a torsion spring interposed between the latch cam and a part integral with the squab frame, and, preferably, towards a position in which it holds the hook in a position in which it unlatches the latching device, if necessary;
the latch cam and the hook are resiliently biased towards each other;
the hook is freely rotatable relative to the squab frame, preferably about an axis oriented transversely to the seat assembly;
the latch cam is freely rotatable relative to the squab frame, preferably about an axis oriented transversely to the seat assembly;
the device for driving the latch cam comprises a second cam, interposed between the first cam and the latch cam, such that the movement of the first cam along the cam path causes the second cam to move, which in turn causes the latch cam to move, from its latched position of the hook into its latched position of the latching device, into another position;
the latch cam is integral with a rod, preferably integral with the latch cam, adapted to be driven by the movement of the second cam to cause the latch cam to move, from its latched position of the hook into its latched position of the latching device, into another position;
the second cam is mounted so as to be rotatable relative to the squab frame, preferably about a transversely oriented axis;
the hook comprises an abutment relief adapted to cooperate with the shaft to cause the hook to move, in particular to rotate if necessary, towards its latched position of the latching device, when the abutment relief abuts against the shaft, in particular when latching the latching device;
the squab frame is mounted so as to be rotatable relative to the movable section, preferably about an axis oriented transversely to the vehicle seat assembly, preferably still in the vicinity of a first longitudinal end of the squab frame, the latching device being adapted to latch together the squab frame and the movable section, in the vicinity of a second longitudinal end of the squab frame, opposite the first longitudinal end;
the vehicle seat assembly comprises:
   at least one connecting rod,
   a linear actuator, preferably a cylinder, more preferably a gas spring mounted at a first end, to pivot about a first axis transverse to the movable section of the at least one slideway, the linear actuator being mounted at a second end to pivot about a second axis transverse to the squab frame, in particular to a front end of the squab frame,
wherein:
   the squab frame is pivotable relative to the movable section of the slideway about a third transverse axis, the third transverse axis being in the vicinity of a front end of the vehicle seat assembly opposite a rear end of the vehicle seat assembly in the longitudinal direction;
   a first end of the at least one connecting rod is mounted so as to pivot relative to the fixed section of the at least one slideway, about a fourth transverse axis;
   the second end of the at least one connecting rod is guided in translation relative to the squab frame, in the longitudinal direction, the at least one connecting rod being pivotable relative to the squab frame about a fifth transverse axis, movable in the longitudinal direction by translation of the second end of the at least one connecting rod relative to the squab frame;
   a stop limiting the movement of the second end of the at least one connecting rod relative to the squab frame in the longitudinal direction, towards the rear end of the vehicle seat assembly;
   the length of the stroke of the movable section relative to the fixed section of the at least one slideway, the length of the at least one connecting rod and the position of the stop being shaped so that a movement of the movable section relative to the fixed section of the at least one slideway tends to increase the distance between the third transverse axis and the fourth transverse axis, while the second end of the connecting rod is in abutment limiting the movement of the second end of the at least one connecting rod relative to the squab frame in the longitudinal direction, towards the rear end of the vehicle seat assembly, causes the squab frame to rotate about the third transverse axis, supported by the action of the linear actuator, the latching device preferably being shaped to unlock at least when the second end of the connecting rod is in abutment limiting the movement of the second end of the at least one connecting rod relative to the squab frame in the longitudinal direction, towards the rear end of the vehicle seat assembly;
   the squab frame comprises a slot or a rib, a slider being received in the slot or on the rib, sliding in the longitudinal direction, the slider being fixed in the vicinity of the second end of the at least one connecting rod, fixed or free to rotate about a transverse axis;
   the stop is formed by a relief adapted to cooperate with the slider to limit the movement of the second end of the at least one connecting rod relative to the squab frame in the longitudinal direction;
   the squab frame comprises a first relief, the at least one connecting rod comprises a second relief and the first and second reliefs are shaped so that, when the slider is moved without being in contact with the stop relief, then the first and second reliefs are not in contact and when the slider is in contact with the stop relief, then the first and second reliefs are in contact so as to prevent the slider from moving away from the stop relief;
   the stop relief is a non-opening longitudinal end of the slot;
   the seat assembly comprises two slideways spaced apart in a transverse direction of the seat assembly, the squab frame being fixed to the movable section of each slideway so as to pivot about the same third transverse axis, a connecting rod is mounted between the fixed section of each slideway rail and the squab frame, the two connecting rods being connected by means of a cross-member, the first end of each connecting rod being mounted so as to pivot relative to the fixed section of a respective slideway about the same fourth transverse axis, and the second end of each connecting rod being guided in translation relative to the squab frame, in the longitudinal direction, the connecting rods being pivotable relative to the squab frame about the same fifth transverse axis, in the vicinity of their second end, the fifth axis being movable in the longitudinal direction by translation of the second end of the connecting rods;
   the seat assembly comprises an actuator, preferably a single one, for controlling the movement of the movable section of the at least one slideway, relative to the respective fixed section; and
   the seat assembly comprises two seats arranged transversely side by side.

Also described is a vehicle, in particular a motor vehicle, comprising a chassis and body defining a passenger compartment with a floor, and at least one seat assembly as described above in any combination thereof, the fixed section of each slideway being attached to the floor or formed by the floor of the passenger compartment.

In particular, the vehicle can have at least one door arranged longitudinally at the level of the seat assembly, and at least one further seat arranged longitudinally behind the seat assembly. The vehicle may be devoid of a door arranged longitudinally at the other seat.

According to yet another aspect, there is described a method of operating a vehicle seat assembly as described above, allowing for switching from a first configuration suitable for accommodating an occupant, to a second configuration of easy entry, the method comprising step i) consisting in moving the movable section of the at least one slideway relative to the associated fixed section in a direction tending to increase the distance between the third transverse axis and the fourth transverse axis while the second end of the at least one connecting rod is in abutment limiting the movement of the second end of the at least one connecting rod relative to the squab frame in the longitudinal direction, towards the rear end of the vehicle seat assembly.

The method may comprise a step ii), preceding the step i), consisting in moving the movable section of the at least one slideway relative to the associated fixed section, until the second end of the at least one connecting rod is in abutment limiting the movement of the second end of the at least one connecting rod relative to the squab frame in the longitudinal direction, towards the rear end of the vehicle seat assembly.

The method may comprise a step of unlatching the latching device, preferably prior to the second end of the at least one connecting rod coming into abutment, limiting the movement of the second end of the at least one connecting rod relative to the squab frame in the longitudinal direction, towards the rear end of the vehicle seat assembly.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a schematic perspective view of an example of a vehicle seat assembly in a first nominal configuration for accommodating at least one occupant, the seat assembly having no upholstery;

FIG. 2 shows a schematic cross-sectional view along plane II-II of an example of a vehicle seat assembly in the position shown in FIG. 1, without upholstery;

FIG. 3 shows a schematic perspective view of a latching device suitable for use in the seat assembly of FIG. 1;

FIG. 4 shows a schematic front view of a subassembly of the latching device of FIG. 3, in the latched position;

FIG. 5 shows a schematic view analogous to FIG. 2, with the upholstery-free seat assembly in an intermediate configuration, between the nominal configuration of FIG. 1 and an easy entry configuration;

FIG. 6 shows a schematic perspective view of a subset of the seat assembly of FIG. 1 in a configuration between the nominal configuration of FIG. 1 and the intermediate configuration of FIG. 5;

FIG. 7 is a view analogous to FIG. 4 showing a first step in unlatching the latching device;

FIG. 8 is a view analogous to FIG. 4 showing a second step in unlatching the latching device;

FIG. 9 is a view analogous to FIG. 4 showing a third step in unlatching the latching device;

FIG. 10 shows a schematic perspective view of a detail of the seat assembly of FIG. 1 in an intermediate configuration between the configuration of FIG. 1 and the configuration of FIG. 5;

FIG. 11 shows a schematic perspective view of a detail of the seat assembly of FIG. 1, with the seat assembly in an easy entry configuration;

FIG. 12 shows a schematic view analogous to FIG. 2, of the seat assembly, without upholstery, in an easy entry configuration;

FIG. 13 is a view analogous to FIG. 4 showing a first step of latching the latch when returning the seat assembly to its nominal configuration;

FIG. 14 is a view analogous to FIG. 4 showing a second step of latching the latch when returning the seat assembly to its nominal configuration; and

FIG. 15 is an analogous view to FIG. 6, with the seat assembly in a so-called emergency exit position.

### DETAILED DESCRIPTION

In the various figures, the same references designate identical or similar elements. For simplicity's sake, only the elements that are useful for understanding the described embodiment are shown in the figures and are described in detail below.

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation of the figures or a vehicle seat in its normal position of use.

In particular, the longitudinal direction X means the longitudinal direction of the seat assembly. The longitudinal direction of the seat assembly is considered to be the same as the longitudinal direction of the motor vehicle wherein the seat assembly is mounted. This longitudinal direction X corresponds to the normal direction of travel of the vehicle. The longitudinal direction X is horizontal. The transverse direction Y of the seat assembly thus corresponds to the transverse or lateral direction of the motor vehicle. This transverse direction corresponds to a direction perpendicular to the normal direction of travel of the vehicle. The transverse direction Y is horizontal. Finally, the vertical direction Z is a vertical direction of the seat assembly, perpendicular to the longitudinal direction and the transverse direction.

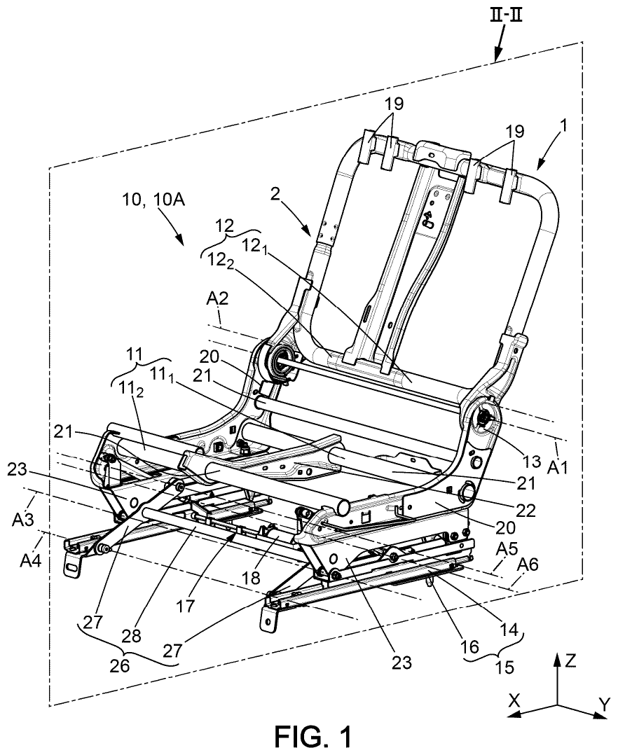

FIG. 1 schematically shows a detail of a motor vehicle seat assembly 10. Such a seat assembly 10 is generally arranged at the rear of a motor vehicle, behind one or more so-called front seats, in the direction X of normal motor vehicle travel. In particular, the front seat(s) can be closer to a motor vehicle steering wheel. In particular, the motor vehicle can have two or three front seats. The front seats can be distinct and separate, or even spaced apart in the transverse direction Y. A console can then be positioned between two front seats, and in front of the seat assembly 10.

In the shown example, the seat assembly 10 comprises two seats 1, 2. Alternatively, the seat assembly 10 may form a single seat or more than two seats, in particular three seats or even more than three seats.

As shown, the seat assembly 10 comprises a squab frame 11 and a backrest frame 12. The backrest frame 12 is pivotably mounted relative to the squab frame 11 about a first transverse axis A1, by means of an articulation device 13. The articulation device 13 is not described in greater detail here. The articulation device 13 can be used to adjust the tilt of the backrest frame 12 relative to the squab frame 11 and/or to fold the backrest frame 12 towards the squab frame 11. The articulation device 13 can thus be used to fold down the entire backrest of the seat assembly 10 simultaneously.

Here, the backrest frame 12 of the seat assembly 10 defines a backrest frame 12₁ of a first seat 1 of the seat assembly 10, and a backrest frame 12₂ of a second seat 2 of the seat assembly 10. Advantageously, at least part of the backrest frame 12₂ of the second seat 2 is pivotably mounted relative to the squab frame 11 about a second transverse axis A2, independently of the backrest frame 12₁ of the first seat 1. In this way, it is possible to fold down the backrest of the second seat 2 while leaving the backrest frame 12₁ of the first seat 1 in position to accommodate an occupant of the first seat 1. This is particularly interesting in the example shown, where the backrest of the second seat 2, which is narrower than the backrest of the first seat 1, is intended to be arranged substantially in the middle of the vehicle and can be folded down to be used as an armrest for an occupant of the first, side seat 1, or of another side seat, which is arranged symmetrically to the first seat 1, with respect to the second seat 2 and which is not formed, in the example shown, by the seat assembly 10.

The squab frame 12 is mounted on movable sections 14, also called sliders or male sections, of slideways 15. Each movable section 14 is associated with a fixed section 16 in a slideway 15. The fixed section 16 is also called “rail” or “female section.” The fixed section 16, for example, is attached to the floor of the motor vehicle, formed by the body or chassis of the motor vehicle. The fixed 16 and movable 14 sections of the slideways 15 may generally be metallic. A slideway 15 here is located on each side of the squab frame 12. The slideways 15 are separated from one another, in the transverse direction Y. The two slideways 15 are parallel and extend in the longitudinal direction X.

The seat assembly 10 comprises an actuator 17 for synchronously controlling the movement of the movable section 14 of the two slideways 15, relative to the associated fixed section 16. The actuator 17 is not described in greater detail here. The actuator 17 comprises a motor 18, preferably a single motor 18. The motor 18 can be positioned between the two slideways 15, as shown in FIG. 1. The actuator 17 is associated with at least one device for translational latching of the movable section 14 of one of the slideways 15 with respect to the associated fixed section 16, the actuator 17 preferably being associated with two such translational latching devices, each latching device making it possible to lock the sliding of a respective movable section 14 with respect to the associated fixed section 16. Once the latching device(s) is/are unlatched, the movable sections 14 can slide, under the action of the actuator 17, relative to their respective fixed sections 16, in the longitudinal direction X of the slideways 15, corresponding to the longitudinal direction of the seat assembly 10.

Alternatively, the movement of the movable section(s) 14 relative to the associated fixed section(s) 16 is achieved by pulling or pushing on the squab frame 11 and/or backrest frame 12. In this case, the seat assembly 10 may be devoid of an actuator 17.

Each seat 1, 2 may comprise a headrest (not shown in the figures). For example, sockets 19 for receiving headrest support rods can be attached to the backrest frame 12₁, 12₂ of each seat 1, 2. Here, sockets 19 are welded to the backrest frames 12₁, 12₂ of the seats 1, 2. The headrest support rod(s) can be of variable length to allow the height of the headrest position to be adjusted. Alternatively or additionally, a headrest frame of each headrest is movable relative to the headrest support rod(s) to enable this height adjustment of the headrest position.

Each seat 1, 2 further comprises a squab frame 11₁, 11₂, the two squab frames 11₁, 11₂ being formed by the squab frame 11 of the seat assembly 10. Here, the squab frames 11₁, 11₂ of the two seats 1, 2 are fixed to each other, the two squab frames 11₁, 11₂ being integral.

The squab frame 11 of the seat assembly 10 comprises two lateral flanges 20, connected by cross-members 21. Here, the squab frame 11 comprises three cross-members 21, one of which is arranged in the vicinity of a front end of the seat assembly 10 and two of which are arranged in the vicinity of a rear end of the seat assembly 10. A longitudinal member 22, located between the cross-member 21 located near the front end of the seat assembly 10 and one of the cross-members 21 located near the rear end of the seat assembly 10, delimits the squab frames 11₁, 11₂ of the seats 1, 2.

The squab frame 11 of the seat assembly 10 further comprises two lateral supports 23. Each lateral flange 20 is rigidly attached to a respective lateral support 23. In this way, each lateral flange 20 is integral with a respective lateral support 23. Each lateral support 23 is pivotably mounted about a third transverse axis A3—common to both lateral supports 23—relative to a movable section 14 of a respective slideway 15. Thus, here, the third axis A3 is movable along the longitudinal direction X. The third axis A3 is preferably located in the vicinity of a front end of the lateral supports 23 and/or the movable sections 14 of the slideways 15.

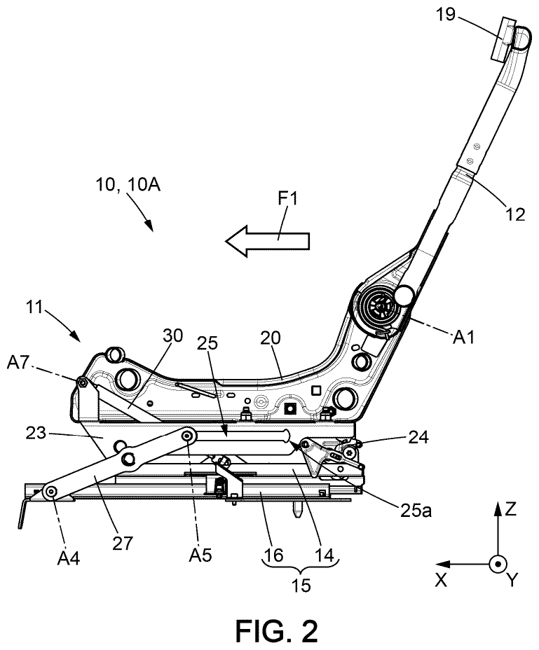

In the position shown in FIGS. 1 and 2, pivoting the lateral supports 23 relative to the third transverse axis A3 is prevented by a latching device 24 connecting a lateral support 23 to a respective movable section 14. A latching device 24 can be fitted to each lateral support 23. For example, each latching device 24 comprises a shaft integral with a mobile profile 14 of a slideway 15, and an associated hook, linked to the squab frame 11, in particular one of the lateral supports 23. For example, each shaft is at least partially received in a recess formed by the hook, in the latched position of the latch 24, the hook releasing the shaft in an unlatched position of the latch, that is to say when the shaft is no longer received in the hook recess.

Furthermore, as can be seen in [FIG. 2], each lateral support 23 has a slot 25, extending in the longitudinal direction X of the seat assembly 10. Each slot 25 has a closed rear end 25a. Here, each slot 25 forms a notch at its rear end 25a. For example, the notch is substantially circular, with a diameter greater than the width of the rest of the slot 25. According to the shown example, each slot 25 also has a front end 25b, also closed. In this way, each slot 25 is of finite length. The length of each slot 25 is less than the stroke length of the movable sections 14 in the respective fixed sections 16.

The seat assembly 10 further comprises a structure 26, here shaped like an “H”, connecting the squab frame 11, in particular the lateral supports 23, to the fixed sections 16 of the slideways 15. In this way, in the example shown, the connecting structure 26 comprises two connecting rods 27 joined together by a cross-member 28. The two connecting rods 27 and the cross-member 28 are thus integral.

The two connecting rods 27 are pivotably mounted relative to a respective fixed section 16 at a first end, about a common, fourth transverse axis A4. This fourth transverse axis A4 is fixed.

Each connecting rod 27 is also pivotably mounted about a fifth transverse axis A5, at a second end, relative to a slideway 29 guided in translation along the longitudinal direction X, by the slot 25 of a respective lateral support 23. The fifth transverse axis A5 is thus movable along the longitudinal direction X of the seat assembly 10.

The seat assembly 10 further comprises a gas spring 30. In a suitable manner, such a gas spring 30, a piston forming a first longitudinal end of the gas spring 30 is pushed away from a gas spring body forming a second longitudinal end of the gas spring 30, by a pressurized gas received in a chamber delimited by the piston and the gas spring body.

The gas spring 30 is pivotably mounted, at a first end, relative to a movable section 14 of a slideway 15, about a sixth transverse axis A6. The gas spring 30 is also pivotably mounted, at a second end opposite the first end, relative to the squab frame 11, more precisely here a flange 20 of the squab frame 11, about a seventh transverse axis A7. The sixth and seventh axes A6, A7 are thus movable in the longitudinal direction X of the seat assembly 10.

In the following, a latching device 24 is described which is particularly suitable for use in the seat assembly 10 described above. Indeed, the latching device 24 is adapted to be latched/unlatched automatically, depending on the position of the movable sections 14 of the slideways 15 relative to the fixed sections 16. Advantageously, the latching device 24 is mechanical, devoid of any electronic means, in particular electrical sensors or actuators.

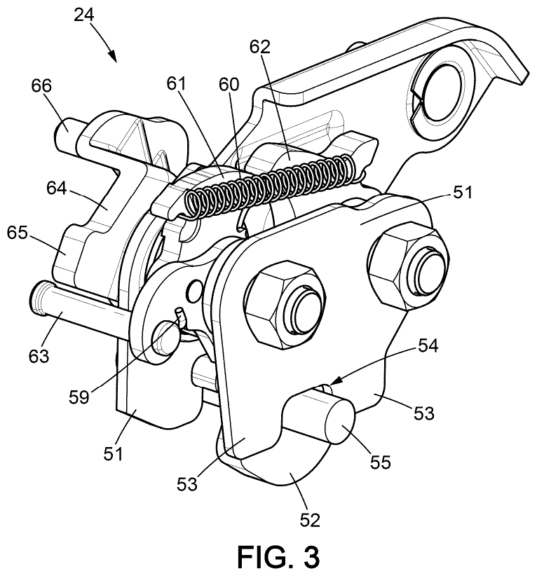

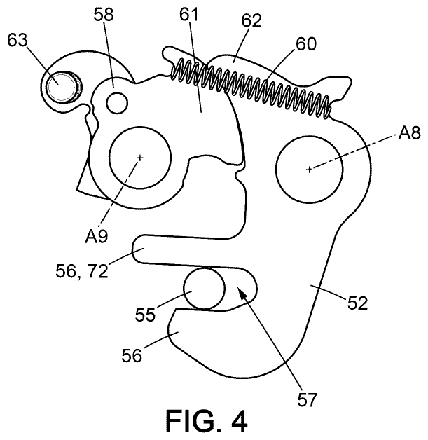

As shown in FIGS. 3 and 4, the latching device 24 here comprises hooks 51, 52 (or jaws). Two hooks 51 are fixed relative to the squab frame 11 and one hook 52 is movable, here pivotably mounted relative to the squab frame 11, around an eighth transverse axis A8.

Each fixed hook 51 has two teeth 53 extending vertically downwards, framing a recess 54 adapted to receive a shaft 55, extending substantially in the transverse direction Y of the seat assembly 10, the shaft 55 being integral here with the movable section 14 of a slideway 15. Thus, when the shaft 55 is received in the recess 54 of a fixed hook 51, the fixed hook 51 limits or even prevents a relative movement of the squab frame 11 with respect to the movable section 14 of a slideway 15, in the longitudinal direction X, on the one hand, and in the vertical direction Z, in the direction of the squab frame 11 towards the movable section 14, on the other hand.

Similarly, the movable hook 52 has two teeth 56 extending, with the movable hook 52 in its latched position of the latching device 24, horizontally towards the rear of the vehicle seat assembly 10, framing a recess 57 adapted to receive the shaft 55. The movable hook 52, in its latched position of the latching device 24 wherein the shaft 55 is received in its recess 57, limits or even prevents a relative movement of the squab frame 11 with respect to the movable section 14 of a slideway 15, on the one hand in the vertical direction Z, and on the other hand in the horizontal direction X, such that the squab frame 11 and the movable section 14 move away from one another.

The movable hook 52 is pivotably mounted about an eighth transverse axis A8 in relation to the fixed hooks 51 of the latching device 24 and, more generally, in relation to the squab frame 11.

To hold the movable hook 52 in its latched position, the latching device 24 features a latch cam 58. The latch cam 58 is movable. Here, the latch cam 58 is pivotably mounted relative to the fixed hooks 51 of the latching device 24, about a ninth transverse axis A9. The latch cam 58 is resiliently biased into a position, shown in FIGS. 3 and 4, where it blocks the movable hook 52 in its latched position. Here, the resilient bias is achieved by means of a torsion spring 59 arranged between the latch cam 58, on the one hand, and one of the fixed hooks 51, on the other. In addition, latch cam 58 and movable hook 52 are resiliently biased towards each other, here by means of a tension spring 60 arranged between the latch cam 58 and the movable hook 52. The latch cam 58 has an abutment relief 61 adapted to cooperate with a complementary abutment relief 62, on the movable hook 52, to hold the movable hook 52 in its latched position, notably under the action of the torsion spring 59.

The latch cam 58 is integral with a rod 63 extending parallel to the transverse direction Y. In particular, the rod 63 and latch cam 58 can be made from a single material.

The rod 63 is shaped to cooperate with a first cam 64, whose cam relief 65, abutting against the rod 63, enables the latch cam 58 to rotate about its axis of rotation A9 when the first cam 64 pivots about its own axis of rotation A10, in this case a transverse axis.

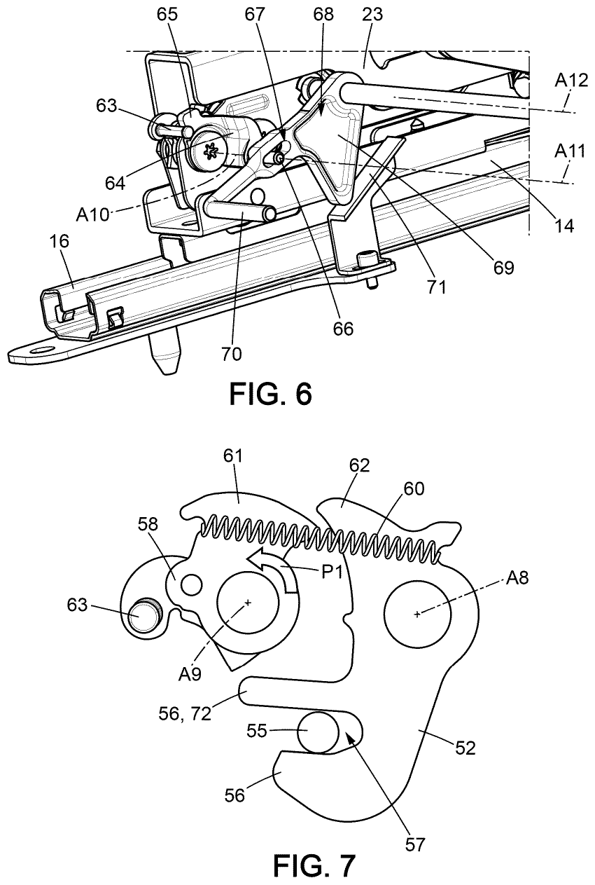

The first cam 64 in turn has, according to the example shown, a pin 66 extending parallel to the transverse direction Y of the seat assembly 10. As can be seen in FIG. 6, this pin 66 is received in an oblong opening 67 of a second cam 68. The pin 66 is adapted to pivot relative to the second cam 68 about an eleventh transverse axis A11, movable within the oblong opening 67.

The second cam 68 is pivotably mounted relative to a fixed hook 51 about a twelfth transverse axis A12. Here, the second cam 68 has a generally triangular-shaped portion 69, with rounded corners, on a first side of the oblong opening 67. On the other side of the oblong opening 67, the second cam 68 has an “L”-shaped portion 70, one leg 70₁ of which extends in a plane (X, Z) and the other leg 70₂ of which extends parallel to the transverse direction Y. The second leg 682 is adapted to be grasped by a rear seat occupant, to manipulate the second cam 68, in particular to rotate it about its axis of rotation A11. The “L”-shaped portion 70 of the second cam 68 thus enables the latching device 24 to be manual unlatched by a seat occupant located behind the seat assembly 10. However, the portion 70 is optional. The portion 70 can also be shaped differently.

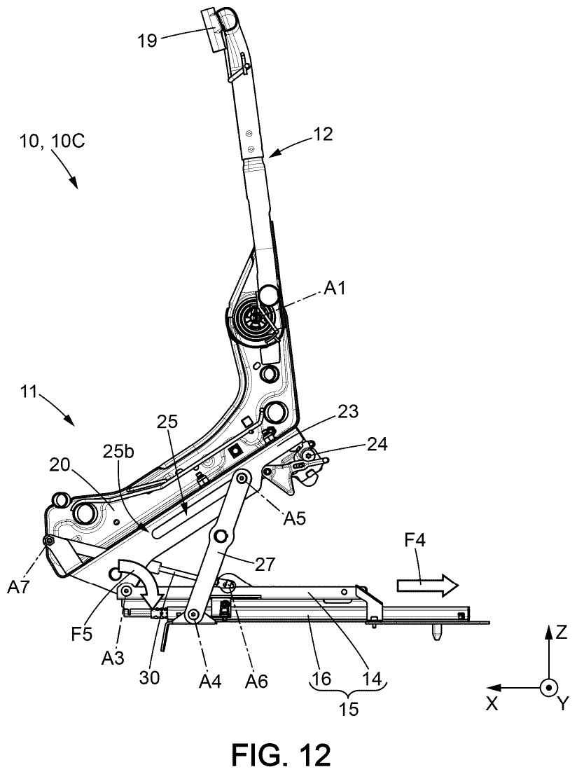

The following describes the kinematics for changing the configuration of the seat assembly 10, from a first configuration 10A shown in FIG. 2, allowing the reception of at least one occupant of the seat assembly 10, to an easy entry configuration 10C shown in FIG. 12.

As indicated above, in FIG. 2, the seat assembly 10 is in a first configuration 10A allowing the accommodation of at least one occupant of the seat assembly 10. Note that this first configuration 10A for accommodating at least one occupant is variable. In particular:
the backrest frame 12 can be tilted to a greater or lesser extent relative to the squab frame 11 about the first transverse axis A1;
the backrest frame 12 can even be folded down opposite the squab frame 11;
the longitudinal position of the movable sections 14 can be different from the fixed sections 16 of the slideways 15, for example to accommodate larger or smaller occupants. The longitudinal position of the movable sections 14 in the first configuration 10A can a priori be varied over the entire range permitted by the length of slot 25, receiving the slideway 29.

In any case, in this first configuration 10A of the seat assembly 10, the latching device(s) 24 is (are) closed, preventing the squab frame 11 from rotating relative to the movable sections 14 of the slideways 15, about the third transverse axis A3. Thus, as shown in FIG. 4, the movable hook 52 is in its latched position of the latching device 24, with the shaft 55 received in the recess 57 between the two teeth 56 of the movable hook 52. The movable hook 52 is resiliently biased by the spring 60 against the latch cam 58, into a position wherein the stop reliefs 61, 62 of the movable hook 52 and latch cam 58 are in contact with each other so as to prevent the movable hook 52 from rotating and thus unlatching the latching device 24. The latch cam 58 is also resiliently biased in its position shown in FIG. 4, by the torsion spring 59.

The latches of the slideways 15 are also closed, to prevent the movable sections 14 from moving relative to the fixed sections 16.

From the configuration 10A shown in FIG. 2, to switch to the configuration 10C for access to the rear seats, first the opening of the latches of the slideways 15, and a movement F1, along the longitudinal direction X, of the movable sections 14, of the slideways 15 relative to the fixed sections 16, are commanded. This movement is here effected by the slideway actuator 17.

During this movement, the slider 29 is moved inside the slot 25 until it comes to rest at the rear end 25a of the slot 25. The seat assembly 10 is then in a second, intermediate configuration 10B, shown in FIG. 3.

Preferably, the latching device(s) 24 is (are) latched over the greater part of the movement F1. In this way, preferably, the latching device(s) 24 is (are) kept latched for the greater part of the movement F1, preferably substantially until each slider 29 comes into abutment against the rear end 25a of the slot 25. The latching device(s) 24 are therefore preferably unlatched when the slider 29 comes to rest on the rear end 25a of the slot 25, being received in the notch formed there, or just before the slider 29 comes to rest on the rear end 25a of the slot 25.

To this end, as shown in FIG. 6, during the movement of the movable sections 14, the triangular part 69 of the second cam 68 comes into contact with and follows a ramp 71, fixedly mounted with respect to the fixed sections 16 of the slideways 15. The ramp 71 can be attached to the fixed section 16 or fixed to the motor vehicle chassis. Alternatively, the ramp 71 is integral with the fixed section 16 of the slide 15.

With the triangular portion 69 of the second cam 68 following the ramp 71, the second cam 68 pivots around its axis of rotation A12. This rotation of the second cam 68 causes the first cam 64 to rotate in the opposite direction about its axis of rotation A10, the pin 66, received in the oblong opening 67, being driven by the rotation of the second cam 68. The cam relief 65 of the first cam 64 then causes the latch cam 58 to pivot P1 about its axis of rotation A9, by pushing on the rod 63.

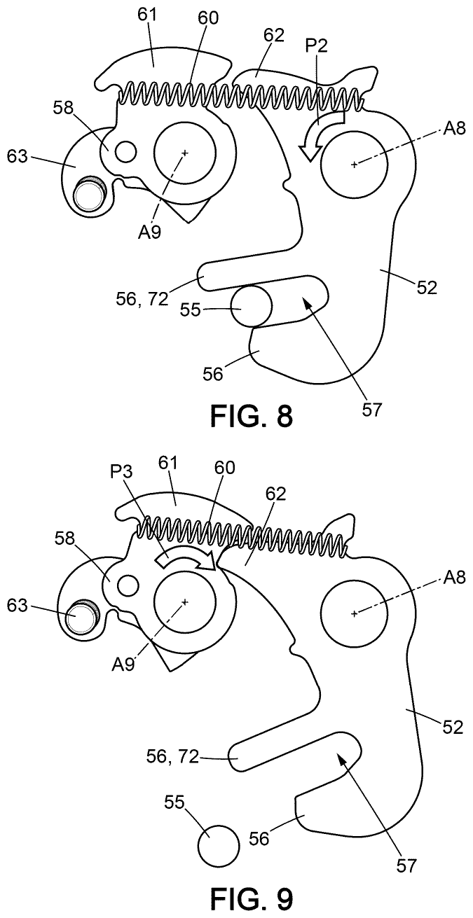

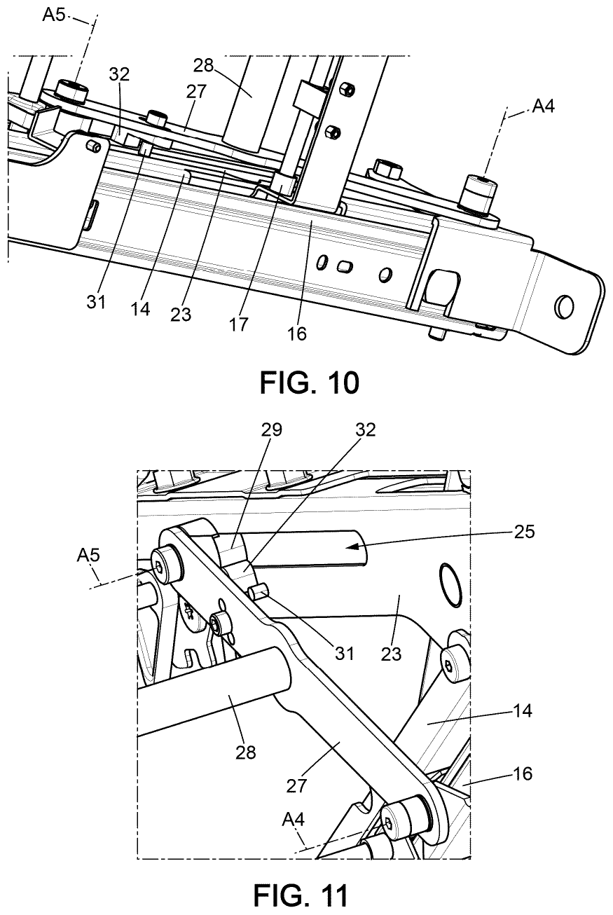

As shown in FIGS. 7 and 8, the pivoting P1 of the latch cam 58 about its axis of rotation A9 is such that the two stop reliefs 61, 62 are no longer in contact, allowing the movable hook 52 to pivot P2 about its axis of rotation A8, driven by the tension spring 60, until it comes into abutment against the latch cam 58. In so doing, the movable hook 52 releases the shaft 55, so that the squab frame 11 of the seat assembly 10 can be pivoted about the third transverse axis A3, to raise the rear end of the squab frame 11 relative to the front end of the squab frame 11, located in the vicinity of the third transverse axis A3.

As the movable section 14 continues to move relative to the fixed section 16 and/or the squab frame 11 begins to pivot about the third transverse axis A3, the triangular portion 69 of the second cam 68 is no longer in contact with the ramp 71. The torsion spring 59 then returns the latch cam 58, which pivots P3 about its axis of rotation A8 towards its position of latching the movable hook 52 in its position of latching the latching device 24. The stop reliefs 61, 62 are then in contact again, but on different surfaces, so that the movable hook 52 is latched in an unlatched position of the latching device 24, by the latch cam 58.

It should be noted that during this movement of the slider 29 in the slot 25, a first relief 31 of the squab frame 11, here of a lateral support 23, shaped to extend towards a respective connecting rod 27 of the connecting structure 26, does not come into contact with a second relief 32 on the respective connecting rod 27. Here, the first relief 31 takes the form of a cylindrical pin, the axis of which is parallel to the transverse direction Y of the seat assembly 10. The second relief 32 is substantially L-shaped, with a first leg extending along the connecting rod 27 and a second leg extending parallel to the transverse direction Y, to the vicinity of the lateral support 23—that is, the free end of the second leg of the second relief 32 is at a distance from the lateral support 23 less than the height of the pin forming the first relief 31, measured along the transverse direction Y. Indeed, the pin forming the first relief 31 extends vertically below the second leg of the second relief 32 when the slider 29 travels through the slot 25, without abutting against the rear end 25a of the slot 25.

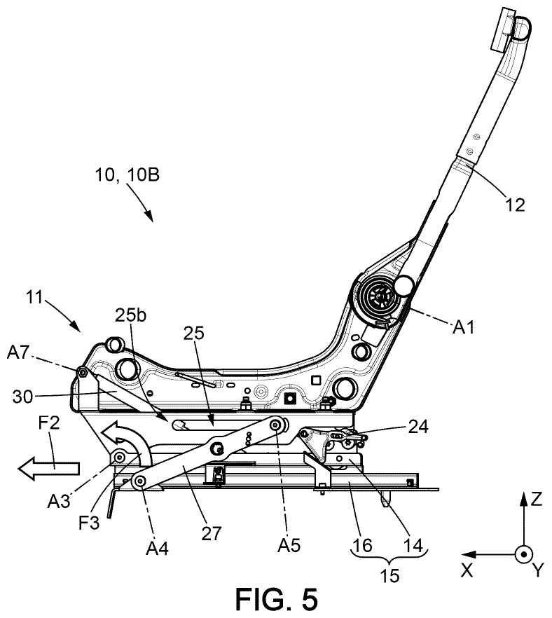

However, when the slider 29 comes into abutment against the rear end 25a of the slot 25, being received in the notch formed therein, then first relief 31 is in abutment against second relief 32 as shown in FIG. 5. As the notch is circular and has a diameter greater than the width of slot 25, the second relief 32 extends vertically lower when the slideway 29 is received in the notch, than when the slideway 29 traverses the rest of slot 25 and is opposite the first relief 31. The stop between the first and second reliefs 31, 32 then prevents relative movement of the slideway 29 in the slot 25 and, in so doing, a sliding movement in the direction of the slot 25, of the squab frame 11 relative to the movable section 14.

From the intermediate position 10B of FIG. 5, the squab frame 11 is tilted forward (see arrow F3) about the third transverse axis A3, this being made possible by unlatching the latching device(s) 24 just before the seat assembly 10 reaches the second intermediate configuration 10B or when the seat assembly 10 has reached the second intermediate configuration 10B.

In this case, the continuous movement F2 of the movable sections 14 relative to the fixed sections 16 tends to increase the distance between the third axis A3, of rotation of the squab frame 11 relative to the movable sections 14 of the slideways 15, on the one hand, and the fourth axis A4, of rotation of the connecting rods 27 relative to the fixed sections 16 of the slideways 15, on the other hand, causing the squab frame 11 to rotate about the third axis A3, which here results in a forward tilting of the squab frame 11. Here, advantageously, this rotation of the squab frame 11 about the third axis A3 is supported by the gas spring 30. In other words, the gas spring 30 helps to pivot the squab frame 11 about the third axis A3. In this way, the motor 18 of the actuator 17 can maintain reduced characteristics and dimensions, and the actuator can be used primarily to move the movable sections 14 relative to the fixed sections 16, while the contribution of the actuator 17 to the pivoting of the squab frame 11 about the third axis A3 can be reduced. This makes the actuator 17 and the actuator 17 motor 18 smaller, quieter, lighter and less expensive.

The rotation of the squab frame 11, at the end of stroke of the movable sections 14 relative to the fixed sections 16, leads to the easy entry configuration 10C shown in FIG. 12. In this configuration 10C of the seat assembly 10 for access to the rear seats, the squab frame 11 is advantageously pivoted forward, about the third axis A3, by an angle of between 30° and 45° relative to the first configuration 10A. In this way, the seat assembly 10 frees up a substantial amount of space at its foot, making it easier for an individual to pass through to the seats located behind the seat assembly 10. To achieve this forward-tilted position of the squab frame 11, the connecting rods 2 are themselves rotated about the fourth axis A4 through an angle of between 75° and 85°.

Alternatively or additionally, in the easy entry configuration 10C, the backrest frame 12 forms an angle of between 70° and 90° with the vertical direction Z, thus limiting the overall dimensions of the backrest of the seat assembly 10 and further facilitating access to the seats located behind the seat assembly 10.

To return from the easy entry configuration 10C to the first occupant-accommodating configuration 10A of the seat assembly 10, actuator 17 is controlled to move F4 the movable sections 14 rearwards relative to the fixed sections 16. Initially, as shown in FIG. 11, the first and second reliefs 31, 32 are in contact, so that the movement of the mobile profiles 14 tending to bring the third and fourth axes A3, A4 closer together causes the squab frame 11 to rotate F5 about the third axis A3 in the clockwise direction in FIG. 12, tending to fold the squab frame 11 back into contact with the mobile profiles 14 of the slideways 15. As the movement F4 continues, the slider 29 is released from the notch at the rear end 25a of the slot 25, so that the first and second reliefs 31, 32 are no longer in abutment. The slider 29 can then slide in the slot 25, at the same time as the movable sections 14 slide in the fixed sections 16.

The latching of the latching devices 24 can be controlled as follows.

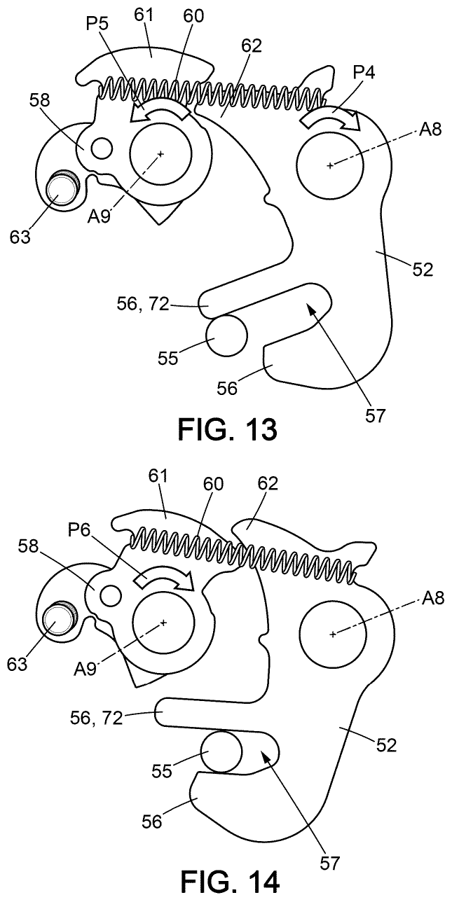

In a first step, shown in FIG. 13, the shaft 55 comes into contact with one of the teeth 56 of the movable hook 52, forming a finger 72 longer than the other tooth 56 of the movable hook 52. This contact occurs, for example, when the squab frame 11 of the seat assembly 10 is folded towards the movable sections 14 of the slideways 15. Contact of the shaft 55 with the finger 72 causes the movable hook 52 to pivot P4 about its axis of rotation A8, tending to move the movable hook 52 away from the cam latch 58. The movable hook 52 is pivoted until it reaches its position of latching the latching device 24, with the stop reliefs 61, 62 no longer being in contact. At the same time, the second cam 68 along the ramp 71 is pivoted P5 to move the stop reliefs 61, 62 apart.

Then, with the second cam 68 no longer being guided by the ramp 71, the latch cam 58 is pivoted P6 about its axis of rotation A9 under the combined action of the torsion spring 59 and the tension spring 60, towards its position of latching the movable hook 52 in its position of latching the latching device 24. The latching device 24 then returns to the configuration shown in FIGS. 3 and 4.

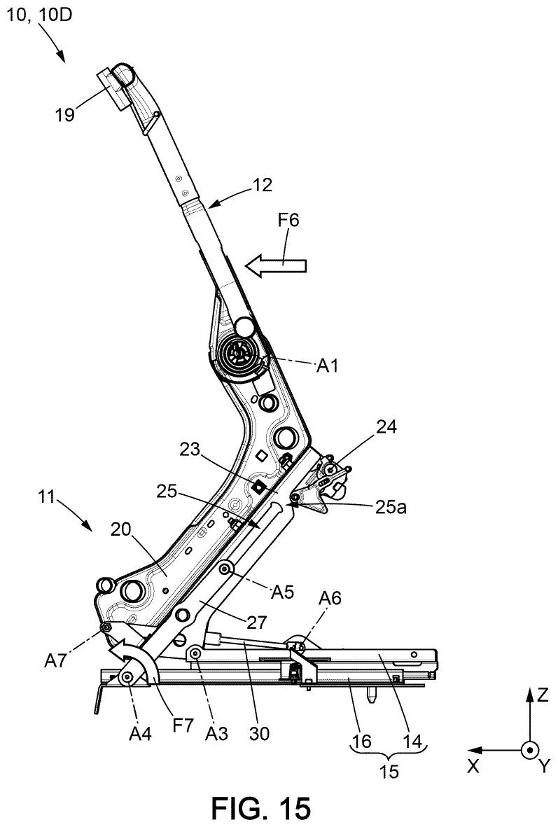

FIG. 15 shows a fourth configuration 10D of the seat assembly 10, enabling an emergency exit of rear-seat occupants, for example in the event of an accident. This configuration 10D differs from the easy entry configuration 10C in that the movable sections 14 of the slideways 15 are not, a priori, in a forward end position (unless correspondingly adjusted in the first configuration 10A). As a result, the sliders 29 do not abut the rear end 25a of the slot 25 in the lateral supports 23 of the squab frame 11. This fourth configuration 10D is achieved by unlatching the latching device(s) 24, for example by means of a device for unlatching the latching device(s) 24 accessible to a rear seat occupant. For example, the occupant of a rear seat activates the second cam 69 directly, for example by gripping the L-shaped portion attached to this second cam 69. Then, the rear seat occupant can push F6 on the backrest frame 12 to cause the squab frame 11 to pivot F7 relative to the movable sections 14 of the slideways 15, about the third axis A3. The gas spring 30 also contributes to the pivoting F7 of the squab frame 11, once the locks have been released. The movable sections 14 are not moved in the fixed sections 16 by the push F6.

As can be seen in FIG. 15, the squab frame 11 is less inclined forward in this fourth configuration 10D than in the easy entry configuration 10C. For example, here the squab frame 11 is inclined at an angle of between 40° and 60° to its position in the first configuration 10A. Similarly, the backrest frame 12 is more inclined with respect to the vertical, so that the backrest frame 12 here has a larger form factor than its form factor in the easy entry configuration 10C of the seat assembly 10. For example, the backrest frame 12 forms an angle of between 60° and 70° with the longitudinal direction X in this fourth configuration 10D of the seat assembly 10. Similarly, the connecting rods 27 are less tilted relative to the horizontal in this fourth configuration 10D than in the easy entry configuration 10C of the seat assembly 10. For example, the connecting rods 27 form an angle of between 40° and 60° with the horizontal, in particular with the longitudinal direction X.

It should be noted here that the latching devices 24 can easily be unlatched by a rear seat occupant, by gripping the second cams 68 by their “L”-shaped portions 70, and pivoting these second cams 68 about their axis of rotation A12. Rotating the second cam 68 causes the first cam 64 to rotate, which in turn pivots the latch cam 58, thereby freeing the movable hook 52 to rotate.

The present disclosure is not limited to the examples described above in relation to the figures. On the contrary, the present disclosure encompasses all the variants and combinations that may be envisaged by the person skilled in the art in the context of the protection sought.

In the case of the examples described, the actuator 17 helps to switch from a nominal configuration to an easy entry configuration. However, in a degraded version, the seat may be without an actuator 17. In this case, the switch from an occupant-accommodating configuration to the easy entry configuration is performed at least partially manually: with each latching device 24 unlatched, the seat assembly 10 is pivoted by exerting a force in the horizontal longitudinal direction X on the seat assembly 10, in particular on the backrest and/or squab. This force may be a push, particularly if exerted by the person behind the seat assembly 10, or a pull, particularly if exerted by a person from outside the vehicle equipped with the seat assembly 10.

Preferably, the number of connecting rods 27 of the connecting device 26 is equal to the number of slideways 15. Alternatively, however, a connecting rod 27 can be provided, even in the case where the seat assembly 10 comprises two slideways 15.

In addition, the seat assembly 10 preferably comprises no other connecting rod(s) or link(s) between these components than those described above. Alternatively, however, the seat assembly 10 may comprise other connecting rods and/or other connections between these components, in particular to provide other seat functionalities, corresponding to configurations other than those described above.

According to another aspect, in the example described, the rod 63 is integral, preferably monolithic with the latch cam 58. Alternatively, the rod 63 is integral, preferably monolithic, with the first cam 64. In this case, the rod 63 is shaped to cooperate with a cam relief of the latch cam 58, so that the pin 63, rotated by the rotation of the first cam 64 and abutting the cam relief of the latch cam 58, causes the latch cam 58 to rotate about its axis of rotation A9 when the first cam 64 pivots about its own transverse axis of rotation A10.

Alternatively, the rod 63, the latch cam 58 and the first cam 64 are integral. For example, the rod 63, the latch cam 58 and the first cam 64 form a single piece.

Additionally, in the examples described, a slider 29 is received in a slot 25, the second end of each connecting rod 27 being pivotably mounted about the fifth axis A5 relative to the slider 29. However, the person skilled in the art can devise other ways of mounting the second end of each connecting rod 27 so that it can pivot about an axis movable in a longitudinal direction, relative to the squab frame 11. For example, the slider 29 can be mounted on a complementary rib.

In the example described, a gas spring 30 is used. However, any suitable linear actuator, that is, any actuator whose length can be varied, can be used by the person skilled in the art, in particular a cylinder. However, the gas spring 30 appears to be a preferable solution in that it does not, a priori, need an external energy source.

In the examples described, again, the longitudinal movement of the sliders 19—and therefore of the fifth axis A5—is limited by the stop of the slider 19 against the longitudinal end 25a of the slot 25. However, the person skilled in the art can devise other means of forming a stop limiting the longitudinal movement of the sliders 19 and, more generally, of the fifth axis A5. For example, the stop may be formed by a relief distinct from the end of the slot 25.

Finally, the latching device described features a second cam 68 cooperating with a ramp 71 to rotate a first cam 64. Alternatively, the second cam 68 cooperating with the ramp 71 drives the latch cam 58 directly in rotation.

In the automotive field, in particular, a comparative vehicle seat may be configured to be able to have a position that facilitates access to the spaces located behind the seat (referred to as the “easy-entry position”). Such a comparative seat may be implemented in a vehicle comprising a number of pairs of doors that is smaller than the number of rows of seats in order to allow access to the last row of seats in the vehicle, that is to say, to the row of seats arranged longitudinally furthest to the rear of the vehicle.

The easy entry position corresponds to a forward-tilted position of the vehicle seat, in particular of the squab of the vehicle seat. When the comparative seat is mounted on slideways, the easy entry position can advantageously also correspond to a position of the seat that is advanced as far as possible towards the front of the motor vehicle.

It was envisaged to use the motor, already present under the comparative vehicle seat to control the longitudinal movement of the vehicle seat along the slideways, to control the passage of the vehicle seat from its nominal position, enabling an occupant of the vehicle seat to be accommodated, to its easy entry position.

However, the weight of the comparative seat makes it necessary to use an oversized motor to move the vehicle seat longitudinally along the slideways.

It was then proposed to implement a spring between a connecting rod controlling the tilting of the comparative vehicle seat into its easy entry position and a latch securing the seat to the movable part of one of the slideways. In particular, the control rod is located at a front end of the vehicle seat and the latch at a rear end. In this case, when the latch is closed, it blocks the comparative vehicle seat from tilting to its easy-entry position, against the stress exerted by the spring. When the latch is open, on the other hand, the spring tilts the comparative vehicle seat into its easy-entry position. However, it proved difficult to control the pivoting of such a vehicle seat with such a spring.

It has also been proposed, to use a torsion bar to control the tilting of the comparative vehicle seat, when the latch holding the squab frame attached to the moving part of at least one of the slideways is open.

In the proposed solutions, it is of interest that the latch securing the seat to the movable element of a slideway can be controlled as a function of the position of the movable element of the slideway relative to the fixed element. It is particularly advantageous that the latch is devoid of electrical and/or electronic means, in order to facilitate maintenance of the vehicle seat.

The present disclosure aims to improve the situation.

To this end, a vehicle seat assembly is described, comprising:
a squab frame;
at least one slideway comprising a movable section received in translation in a fixed section, intended to be fixed to a motor vehicle chassis, the squab frame being mounted so as to be movable relative to the movable section;
a selectively activatable latching device for latching/unlatching at least one movement of the squab frame relative to the movable section, the latching device comprising:
   a shaft integral with the movable section,
   a hook movable between a latched position of the latching device, wherein the hook grips the shaft, and an unlatched position of the latching device, the movable hook being connected to the squab frame, in particular mounted so as to be rotatable relative to the squab frame about a transverse axis,
   a movable latch cam for selectively latching the hook in its latched position of the latching device,
   a device for driving the latch cam between a latched position of the hook in its latched position of the latching device and at least one other position, the drive device of the latch cam comprising a first cam and a cam track adapted so that the first cam drives the latch cam into motion as it travels along the cam track, the cam track being fixed relative to the fixed section.

In this way, the latching device can be purely mechanical, devoid of any electrical or electronic devices, and be adapted to be unlatched when needed, in particular depending on the kinematics to be applied to the seat assembly.

According to preferred embodiments, the seat assembly comprises one or more of the following features, taken alone or in combination:
the latch cam, in a first latched position, holds the hook in a latched position of the latching device, and, in a second latched position, holds the hook in an unlatched position of the latching device;
the latch cam is resiliently biased towards a position in which it holds the hook in its latched position of the latching device, for example by means of a torsion spring interposed between the latch cam and a part integral with the squab frame, and, preferably, towards a position in which it holds the hook in a position in which it unlatches the latching device, if necessary;
the latch cam and the hook are resiliently biased towards each other;
the hook is freely rotatable relative to the squab frame, preferably about an axis oriented transversely to the seat assembly;
the latch cam is freely rotatable relative to the squab frame, preferably about an axis oriented transversely to the seat assembly;
the device for driving the latch cam comprises a second cam, interposed between the first cam and the latch cam, such that the movement of the first cam along the cam path causes the second cam to move, which in turn causes the latch cam to move, from its latched position of the hook into its latched position of the latching device, into another position;
the latch cam is integral with a rod, preferably integral with the latch cam, adapted to be driven by the movement of the second cam to cause the latch cam to move, from its latched position of the hook into its latched position of the latching device, into another position;
the second cam is mounted so as to be rotatable relative to the squab frame, preferably about a transversely oriented axis;
the hook comprises an abutment relief adapted to cooperate with the shaft to cause the hook to move, in particular to rotate if necessary, towards its latched position of the latching device, when the abutment relief abuts against the shaft, in particular when latching the latching device;
the squab frame is mounted so as to be rotatable relative to the movable section, preferably about an axis oriented transversely to the vehicle seat assembly, preferably still in the vicinity of a first longitudinal end of the squab frame, the latching device being adapted to latch together the squab frame and the movable section, in the vicinity of a second longitudinal end of the squab frame, opposite the first longitudinal end;
the vehicle seat assembly comprises:
   at least one connecting rod,
   a linear actuator, preferably a cylinder, more preferably a gas spring mounted at a first end, to pivot about a first axis transverse to the movable section of the at least one slideway, the linear actuator being mounted at a second end to pivot about a second axis transverse to the squab frame, in particular to a front end of the squab frame,
wherein:
   the squab frame is pivotable relative to the movable section of the slideway about a third transverse axis, the third transverse axis being in the vicinity of a front end of the vehicle seat assembly opposite a rear end of the vehicle seat assembly in the longitudinal direction;
   a first end of the at least one connecting rod is mounted so as to pivot relative to the fixed section of the at least one slideway, about a fourth transverse axis;
   the second end of the at least one connecting rod is guided in translation relative to the squab frame, in the longitudinal direction, the at least one connecting rod being pivotable relative to the squab frame about a fifth transverse axis, movable in the longitudinal direction by translation of the second end of the at least one connecting rod relative to the squab frame;
   a stop limiting the movement of the second end of the at least one connecting rod relative to the squab frame in the longitudinal direction, towards the rear end of the vehicle seat assembly;
   the length of the stroke of the movable section relative to the fixed section of the at least one slideway, the length of the at least one connecting rod and the position of the stop being shaped so that a movement of the movable section relative to the fixed section of the at least one slideway tends to increase the distance between the third transverse axis and the fourth transverse axis, while the second end of the connecting rod is in abutment limiting the movement of the second end of the at least one connecting rod relative to the squab frame in the longitudinal direction, towards the rear end of the vehicle seat assembly, causes the squab frame to rotate about the third transverse axis, supported by the action of the linear actuator, the latching device preferably being shaped to unlock at least when the second end of the connecting rod is in abutment limiting the movement of the second end of the at least one connecting rod relative to the squab frame in the longitudinal direction, towards the rear end of the vehicle seat assembly;
the squab frame comprises a slot or a rib, a slider being received in the slot or on the rib, sliding in the longitudinal direction, the slider being fixed in the vicinity of the second end of the at least one connecting rod, fixed or free to rotate about a transverse axis;
the stop is formed by a relief adapted to cooperate with the slider to limit the movement of the second end of the at least one connecting rod relative to the squab frame in the longitudinal direction;
the squab frame comprises a first relief, the at least one connecting rod comprises a second relief and the first and second reliefs are shaped so that, when the slider is moved without being in contact with the stop relief, then the first and second reliefs are not in contact and when the slider is in contact with the stop relief, then the first and second reliefs are in contact so as to prevent the slider from moving away from the stop relief;
the stop relief is a non-opening longitudinal end of the slot;
the seat assembly comprises two slideways spaced apart in a transverse direction of the seat assembly, the squab frame being fixed to the movable section of each slideway so as to pivot about the same third transverse axis, a connecting rod is mounted between the fixed section of each slideway rail and the squab frame, the two connecting rods being connected by means of a cross-member, the first end of each connecting rod being mounted so as to pivot relative to the fixed section of a respective slideway about the same fourth transverse axis, and the second end of each connecting rod being guided in translation relative to the squab frame, in the longitudinal direction, the connecting rods being pivotable relative to the squab frame about the same fifth transverse axis, in the vicinity of their second end, the fifth axis being movable in the longitudinal direction by translation of the second end of the connecting rods;
the seat assembly comprises an actuator, preferably a single one, for controlling the movement of the movable section of the at least one slideway, relative to the respective fixed section; and
the seat assembly comprises two seats arranged transversely side by side.

Also described is a vehicle, in particular a motor vehicle, comprising a chassis and body defining a passenger compartment with a floor, and at least one seat assembly as described above in any combination thereof, the fixed section of each slideway being attached to the floor or formed by the floor of the passenger compartment.

In particular, the vehicle can have at least one door arranged longitudinally at the level of the seat assembly, and at least one further seat arranged longitudinally behind the seat assembly. The vehicle may be devoid of a door arranged longitudinally at the other seat.

According to yet another aspect, there is described a method of operating a vehicle seat assembly as described above, allowing for switching from a first configuration suitable for accommodating an occupant, to a second configuration of easy entry, the method comprising step i) consisting in moving the movable section of the at least one slideway relative to the associated fixed section in a direction tending to increase the distance between the third transverse axis and the fourth transverse axis while the second end of the at least one connecting rod is in abutment limiting the movement of the second end of the at least one connecting rod relative to the squab frame in the longitudinal direction, towards the rear end of the vehicle seat assembly.

The method may comprise a step ii), preceding the step i), consisting in moving the movable section of the at least one slideway relative to the associated fixed section, until the second end of the at least one connecting rod is in abutment limiting the movement of the second end of the at least one connecting rod relative to the squab frame in the longitudinal direction, towards the rear end of the vehicle seat assembly.

The method may comprise a step of unlatching the latching device, preferably prior to the second end of the at least one connecting rod coming into abutment, limiting the movement of the second end of the at least one connecting rod relative to the squab frame in the longitudinal direction, towards the rear end of the vehicle seat assembly.

1. A vehicle seat assembly comprising:
a squab frame;
at least one slideway comprising a movable section received in translation in a fixed section, intended to be fixed to a motor vehicle chassis, the squab frame being mounted so as to be movable relative to the movable section;
a selectively activatable latching device for latching/unlatching at least one movement of the squab frame relative to the movable section, the latching device comprising:
a shaft integral with the movable section,
a hook movable between a latched position of the latching device, wherein the hook grips the shaft, and an unlatched position of the latching device, the movable hook being connected to the squab frame,
a movable latch cam for selectively latching the hook in its latched position of the latching device,
a device for driving the latch cam between a latched position of the hook in its latched position of the latching device and at least one other position, the drive device of the latch cam comprising a first cam and a cam track configured so that the first cam drives the latch cam into motion as it travels along the cam track, the cam track being fixed relative to the fixed section.

2. The vehicle seat assembly according to claim 1, wherein the movable hook is mounted so as to be rotatable relative to the squab frame about a transverse axis.

3. The vehicle seat assembly according to claim 1, wherein the latch cam, in a first latched position, holds the hook in a latched position of the latching device, and, in a second latched position, holds the hook in an unlatched position of the latching device.

4. The vehicle seat assembly according to claim 1, wherein the latch cam is resiliently biased towards a position in which it holds the hook in its latched position of the latching device.

5. The vehicle seat assembly according to claim 4, wherein the latch cam is resiliently biased towards a position in which it holds the hook in its latched position of the latching device by means of a torsion spring interposed between the latch cam and a part integral with the squab frame.

6. The vehicle seat assembly according to claim 4, wherein the latch cam is resiliently biased towards a position in which it holds the hook in a position in which it unlatches the latching device.

7. The vehicle seat assembly according to claim 1, wherein the latch cam and the hook are resiliently biased towards each other.

8. The vehicle seat assembly according to claim 1, wherein the hook is mounted so as to rotate freely relative to the squab frame).

9. The vehicle seat assembly according to claim 8, wherein the hook is mounted so as to rotate freely relative to the squab frame about an axis oriented transversely relative to the vehicle seat assembly.

10. The vehicle seat assembly according to claim 1, wherein the latch cam is mounted so as to rotate freely relative to the squab frame.

11. The vehicle seat assembly according to claim 10, wherein the latch cam is mounted so as to rotate freely relative to the squab frame about an axis oriented transversely relative to the seat assembly.

12. The vehicle seat assembly according to claim 1, wherein the device for driving the latch cam comprises a second cam, interposed between the first cam and the latch cam, such that movement of the first cam along the cam path causes the second cam to move, which in turn causes the latch cam to move from its position latching the hook into its position latching the latching device, into another position.

13. The vehicle seat assembly according to claim 12, wherein the latch cam is integral with a rod configured to be driven by the movement of the second cam to cause the latch cam to move from its position latching the hook into its position latching the latching device, into another position.

14. The vehicle seat assembly according to claim 13, wherein the rod is integral with the latch cam.

15. The vehicle seat assembly according to claim 12, wherein the second cam is mounted so as to be rotatable relative to the squab frame.

16. The vehicle seat assembly according to claim 15, wherein the second cam is mounted so as to be rotatable relative to the squab frame about a transversely oriented axis.

17. The vehicle seat assembly according to claim 1, wherein the hook comprises an abutment relief configured to cooperate with the shaft to cause the hook to move towards its latched position of the latching device, when the abutment relief abuts against the shaft.

18. The vehicle seat assembly according to claim 1, wherein the squab frame is mounted so as to be rotatable relative to the movable section, the latching device being configured to latch together the squab frame and the movable section, in the vicinity of a second longitudinal end of the squab frame, opposite the first longitudinal end.

19. The vehicle seat assembly according to claim 18, wherein the squab frame is mounted so as to be rotatable relative to the movable section about an axis oriented transversely to the vehicle seat assembly.

20. The vehicle seat assembly according to claim 19, wherein the squab frame is mounted so as to be rotatable relative to the movable section about an axis oriented transversely to the vehicle seat assembly in the vicinity of a first longitudinal end of the squab frame.
